(19) United States
(12) Patent Application Publication
(10) Pub. No.: US 2015/0370259 A1
(43) Pub. Date: Dec. 24, 2015

(54) APPARATUS FOR ENHANCING A DRIVER TO DETECT AND ESCAPE FROM A SINKING VEHICLE

(71) Applicant: Geeng-Jen Sheu, Taichung City (TW)

(72) Inventor: Geeng-Jen Sheu, Taichung City (TW)

(21) Appl. No.: 13/707,828

(22) Filed: Dec. 7, 2012

(51) Int. Cl. G05D 3/10; B60J 1/16; B60J 7/043; G01S 19/01; B60J 7/057

(52) U.S. Cl. CPC G05D 3/10; G01S 19/01; B60J 7/0573; B60J 7/043; B60J 1/16

(57) ABSTRACT

An apparatus for enhancing a driver to detect and escape from a sinking vehicle is disclosed. When the thin film pressure with a closed and hollow carrier is detecting an outside water pressure is higher than the first predetermined value and making sure the vehicle is sinking into water, the lifting unit is driven to lower down by the motor which is controlled by the micro-controller unit and simultaneously the window glass is opened. The apparatus further comprises an addressing unit connected to the battery and the micro-controller unit for transmitting automatically a help signal and an addressing signal to at least one predetermined receiving unit to achieve the efficiencies of self-assisting with one's life and escaping from a sinking vehicle in time and extending the rescue time with no delay, uncertainty or inefficiency.

### FIELD OF THE INVENTION

The present invention relates to significantly increase the chances for the drivers to escape from a sinking vehicle, more especially relating to apparatus for enhancing the drivers to detect and escape from a sinking vehicle capable of precisely detecting the sinking situation by the pressure difference between inside and outside of the thin film pressure sensor, and automatically opening the window(s) to escape and sending a help signal and an addressing signal to at least one predetermined receiving unit (e. g. the rescue center) with no delay, uncertainty or inefficiency. The drivers can escape quicker and the chance for survival is increased drastically.

### BACKGROUND OF THE INVENTION

A car is not designed for a plunge into the water. Unfortunately, this happens more often than you may think, not only due to an accident, but also due to flooding. The problem is present wherever there is water and causes several thousands of casualties every year in the world. When a car gets submerged in water, it is not easy and actually sometimes hardly possible for both drivers and passengers to escape. Faults in the electrical power system and water pressure difference make it often impossible to open windows and/or doors. Every year several thousands of people do not survive this horrible situation. The pressure of the water on the doors makes that these cannot be opened temporarily. The pressure problem resolves itself when the car reaches the bottom and is completely filled with water. The pressure of the water is then equalized. However, the drivers are fear and panic that they just had to wait until the vehicle is almost completely submerged. But the chance to escape at this stage will be particularly small. In America, every year even more people drown in their cars caused by flooding than by the car accidentally getting into the water. Flooding can cause the same situation that people get trapped in their cars with hardly a chance to escape.

The fire prevention campaign of National Fire Agency is taught that if the driver is sinking into water starting from the front end of the vehicle which results from the heavy weight of the engine, the driver must calm down, unlock the seat belt at the first time, and open the window to escape before sinking. If the vehicle is totally sinking into water, the vehicle door is not easily opened which is influenced by the difference between inside and outside pressures and the power window is also unable to be started. The vehicle would be totally sinking into water in 90 seconds. The one trapped in the vehicle must find special tools, such as a life hammer or steel-toed shoes, to break the window of the vehicle to escape. However, the car window is usually made of laminated glass and hardly broken. If the glass can not be broken, the one trapped in the vehicle should take a deep breath and hold his breath for minutes to wait the second escaping chance. It means that the one trapped in the vehicle takes a deep breath to open the vehicle door and swim out the vehicle while the inside of the vehicle is almost filled with the water and the inside and outside pressures are almost equalized. Considering the circumstances with fear and panic, it is difficult, even impossible to escape. If the one trapped in the vehicle can not take the escaping chances in 90 seconds started from the vehicle sinking into water, it is hard to rescue the one trapped in the vehicle.

Please refer to FIG. 8, which is showing a schematic drawing of a safety guarding system while a vehicle is driving on the road. There are five phases: phase 1 is normal driving; phase 2 is danger phase; phase 3 is crashing unavoidable; phase 4 is in crash; and phase 5 is post crash.

There are three stages for the safety guarding system: stage 1 is active safety for avoiding a traffic accident; stage 2 is passive safety for reducing personal injury in event of a traffic accident; and stage 3 is post crash for preventing from more follow-up expanded injuries.

The relationship between the stages and the phases are as following. The stage 1 (active safety) is corresponding to phase 1, phase 2, and the first half part of phase 3. The stage 2 (passive safety) is corresponding to the latter half part of phase 3 and phase 4. The stage 3 is corresponding to phase 5.

The development of advanced vehicle safety system is shifting from active safety (stage 1) to passive safety (stage 2), even to post crash (stage 3). The common active safety technology includes ABS, ESP, back sonar, active headlight, head-up display, night view, vehicle anti-collision for keeping distance, and vehicle lane-keeping. However, it is hard to totally prevent the accidents from happening, especially traffic accidents with crash. To reduce the deaths and injuries in the vehicle, it is heading to passive safety to reduce personal injury in event of a traffic accident. The common developed technologies are including seat belt, air bag, frontal-impact crash protection, side-impact crash protection, rear-impact crash protection, and roll-over protection. Some high-classified cars further focus on stage 3 (post crash) to avoid more follow-up expanded injuries. The developing technologies are including automatically shutting off oil circuit, automatically unlocking the central lock system, addressing for alarm and emergency rescue. The data shows that the advanced safety vehicle electrical control system is occupied 40% of total cost of whole vehicle in 2010. It obviously shows that the safety of lives is more respected and emphasized. The passive safety (stage 2) system and the post crash (stage 3) are more important and emphasized. However, they are focused on the passive safety protection system on the traffic accident events.

Because Global Warming and La Niña, the major natural disasters (such as 88 calamity in Taiwan and Australia Floods) are happened and normalized gradually. The one trapped in the vehicle and sinking into water which is hard to be addressed and rescued is frequently happened and broadcasted. The applicant realizes that the accident is not only limited to the traditional traffic accidents. But the rate of death and injury caused by the abnormal climate and sinking accidents with human carelessness is higher than the traffic accidents. Based on the promotion video of U.S. Fire Administration, it shows that there are about 90 seconds (golden time for escape) from the vehicle sinking into water and only smaller than 2% of the ones trapped in the vehicle and sinking into water are able to luckily open the door and the window to escape. Therefore, the passive safety prevention system should be valued further. The applicant is further reviewing the new generation of advanced passive safety system for vehicle sinking into water.

Please reference to Taiwan Publication Patent No. 200726663, which is disclosed a control device of power-driven windows. The control device has a driving circuit, a driving circuit sensor, a signal processing circuit and a control circuit. Wherein the driving circuit is used to control a motor. The driving circuit sensor is used to generate a current signal according to the conditions of driving circuit. The signal processing circuit is used to calculate the velocity of the windows and generate a digital signal. The control circuit is used for generate a working signal for the driving circuit according to the digital signal. The objective is that the device is capable of individually arranging out of the edge of the windows and preventing the rain from entering into the vehicle. The anti-pinch design for power-driven windows is to protect the driver's safety while the vehicle is sinking into water. Although it mentions that the driver's safety protection for vehicle sinking into water, it is used sensors for water immersion detection or rain sensors and easily confused the situations of raining, standing water on the road, car wash, and sinking into water, and further results in erroneous judgment. In accordance with the situation of the vehicle sinking into water, a pressure sensor should be used, but not a sensor for water immersion detection or a rain sensor because there is lateral water pressure difference between inside and outside of the window glass. The pressure sensor can judge that the vehicle is sinking into water but not the situation of raining, standing water on the road, or car wash and not making erroneous judgment while it is detecting that the outer water pressure is higher than a predetermined dangerous pressure value. Moreover, it can not address and immediately and automatically transmit a help signal for the sinking situation and result in losing the rescue timing. Finally, it will lose power after the vehicle is sinking into water and result in all circuits unable to work. It can't protect the driver's safety in time for the sinking situation.

Please reference to China Utility Patent No. 201020210499, which is disclosed an automatic open device for car windows. The device comprises a central control module, a thermal detecting module, a pressure detecting module, a floating detecting module, and window control module. a backup battery module is mounted at the outer side of the central control module, the thermal detecting module is mounted at one side of a power generator, the pressure detecting module and the floating detecting module are mounted at the front end and lower side of the vehicle and adjacent to the power generator. The window control module is arranged on the body of the vehicle between the central control module and the window. It is able to judge if the windows are opened automatically according to the signals transmitted from the detecting modules to safely escape for the one trapped in the vehicle while the vehicle is on fire or sinking into water. In accordance with the sinking part, the pressure detecting module and the floating detecting module arranged at the front end and lower side of the vehicle is detecting if the vehicle is sinking into water, and it would confused the situations of raining, standing water on the road, and car wash and then make erroneous judgment. There are disadvantages of occupying space, response delay for mechanical signals, and easy to be damaged, due to the mechanical design pattern. Furthermore, the rescue timing has lost because it can not automatically transmit an addressing signal and a help is signal while the vehicle is sinking into water. Finally, it also exists the problem of power loss resulting in all circuits unable to work while the vehicle is sinking into water, and it is impossible that the windows are automatically opened to make the driver escape as quickly as possible.

Please further reference to China Utility Patent No. 200620132897, which is disclosed a self-rescue device for windows of motor vehicle. An emergency switch is mounted at the bottom beam disposed at the front side of the vehicle. A float rod is arranged inside a box of the emergency switch, and a floating ball is mounted on the float rod. The float rod is mounted on the box by an axle pin. A lower touch point is arranged on the float rod, a connection rod is arranged at the upper end of the floating ball, and an upper touch point is arranged on the connection rod. Power lines are arranged on the float rod and connection lines are arranged on the connection rod. The power lines are connected to the window lifting device via the float rod and the connection rod. When the emergency switch is sinking into water, the floating ball in the box is floating upwardly to connect the power to start the lifting device to automatically open the window to escape for the driver's rescue. However, the disadvantage is similar to the China Utility Patent No. 201020210499.

To avoid aforementioned disadvantages, the applicant had filed an application (Taiwan Publication Patent No. 100114760) which is mainly used a thin film pressure sensor. It can save space and be attached directly at a surface of the window glass or embedded in the window glass. And the detected signal is real-time electrical signal, instead of mechanical signal. The escape by automatically opening windows, automatically transmitting the GPS addressing signal and the help signal, or both are capable of be achieved while the vehicle is sinking into water until a depth with a predetermined dangerous pressure value.

The advantages of the aforementioned application are used the thin film pressure sensor to detect the sinking depth. The automatic escape and rescue device is active while the detected pressure P of the thin film pressure sensor attached at the surface of the window glass is higher than the first predetermined pressure value P1. Because the distribution pattern of the predetermined pressure value P1 is different from the situations of raining, standing water on the road, and car wash, it can not be confused and make erroneous judgment. Please refer to FIG. 4, the thin film pressure sensor can detect the sinking depth and the automatic escape and rescue device can be active until the sinking depth is raising to 5-10 cm from the bottom of the window glass (e.g. it is almost located at the chest of the driver). It will be wasted the 20-30 seconds (golden time) for escape. If the thin film pressure sensor is attached at the front end of the vehicle, it can detecting the vehicle sinking at the initial stage while the vehicle is sinking from the front end of the vehicle resulting from the heavy engine. It will strive for more rescue time and have better safe prevention system than the disclosure of Taiwanese Patent Application No. 100114760.

However, the front end of the body of the vehicle is open space, not closed space as vehicle compartment, the front end of the body of the vehicle will be filled with water for the sinking situation. If the conventional thin film pressure sensor is directly attached at the front of the body of the vehicle, it will be not able to detect the sinking depth because no water pressure difference exists between the both sides of the thin film pressure sensor. But it can be overcome by arranging a closed and hollow carrier in the body of thin film pressure sensor. Please reference to FIGS. 2 and 3, the signals of pressure sensor can be generated by taking the pressure difference between the both sides of the membrane for the sinking situation. Please also reference to FIG. 4, the thin film pressure sensor with the closed and hollow carrier, attached at the front end of the vehicle, can be detecting the sinking situation at the initial stage while the vehicle is sinking from the front end of the vehicle resulting from the heavy engine. It will strive for more rescue time and have better safe prevention than the disclosure of Taiwanese Patent Application No. 100114760.

### SUMMARY OF THE INVENTION

An objective of this invention is providing an apparatus for enhancing a driver to detect and escape from a sinking vehicle capable of automatically detecting the sinking depth, automatically opening the window(s) of the vehicle, and automatically transmitting the help signal and the addressing signal to achieve the efficiencies of self-assisting with one's life and escaping from a sinking vehicle in time and extending the rescue time.

To achieve above objectives, an apparatus for enhancing a driver to detect and escape from a sinking vehicle, which is disposed at a body of a vehicle, the body is including at least one window and at least one window glass, the vehicle is further comprising a battery, and the apparatus comprising: a micro-controller unit, disposed in the body and electrically connected to the battery, the micro-controller unit is set a first predetermined pressure value; a motor, disposed in the body and electrically connected to the battery and the micro-controller unit; a lifting unit, disposed in the body and cooperated with the window glass, the lifting unit is controlled by the motor to go up or down; and a thin film pressure sensor with a closed and hollow carrier, disposed at a front end of the body and electrically connected to the battery and the micro-controller unit.

Wherein the motor is controlled by the micro-controller unit to rotate and make the lifting unit go down and simultaneously to drive the window glass downward to open the window while the vehicle (a car) is sinking into water and an outer water pressure detected by the thin film pressure sensor with a closed and hollow carrier is higher than the first predetermined pressure value.

The apparatus further comprises an addressing unit, which is a GPS electrically connected to the battery and the micro-controller unit for transmitting a help signal and an addressing signal to at least one predetermined receiving unit. The apparatus further comprises an UPS unit electrically connected to the battery. The UPS unit is a solar thin film UPS unit, which is attached to a surface of the window glass or embedded in the window glass. The micro-controller unit is further set a second predetermined pressure value for transmitting the help signal and the addressing signal to the at least one receiving unit by the addressing unit while the outer water pressure detected by the thin film pressure sensor with a closed and hollow carrier is higher the second predetermined pressure value.

To achieve above objectives, an apparatus for enhancing a driver to detect and escape from a sinking vehicle, which is disposed at a body of a vehicle, the body is including at least one window and at least one window glass, the vehicle is further comprising a battery, and the apparatus comprising: a micro-controller unit, disposed in the body and electrically connected to the battery, the micro-controller unit is set a predetermined pressure value; an addressing unit, electrically connected to the battery and the micro-controller unit for transmitting a help signal and an addressing signal to at least one receiving unit; and a thin film pressure sensor with a closed and hollow carrier, disposed at a front end of the body and electrically connected to the battery and the micro-controller unit.

Wherein the help signal and the addressing signal are transmitted to the at least one receiving unit by the addressing unit while the vehicle (a bus) is sinking into water and an outer water pressure detected by the thin film pressure sensor with a closed and hollow carrier is higher than the predetermined pressure value.

The apparatus further comprises a UPS unit electrically connected to the battery and attached to a surface of the window glass or embedded in the window glass. The UPS unit is a solar thin film UPS unit, which is attached to a surface of the window glass or embedded in the window glass.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a schematic drawing of a first embodiment in accordance with the present invention.

FIG. 2 is a schematic drawing of a thin film pressure sensor with a closed and hollow carrier having thin-walled and circular ring section in accordance with the present invention.

FIG. 3 is a schematic drawing of a thin film pressure sensor with a closed and hollow carrier having thin-walled and hollow box section in accordance with the present invention.

FIG. 4 is a schematic drawing of a vehicle sinking into water from the front end of the vehicle resulting from a heavy engine loaded at the front end of the vehicle.

FIG. 5 is an operation process of the first embodiment in accordance with the present invention.

FIG. 6 is a schematic drawing of a second embodiment in accordance with the present invention.

FIG. 7 is an operation process of the second embodiment in accordance with the present invention.

FIG. 8 is a schematic drawing of a safety guarding system of vehicle with respect to traffic accidents on road.

### DESCRIPTION OF THE PREFERRED EMBODIMENT

Referring now to the drawings where like characteristics and features among the various figures are denoted by like reference characters.

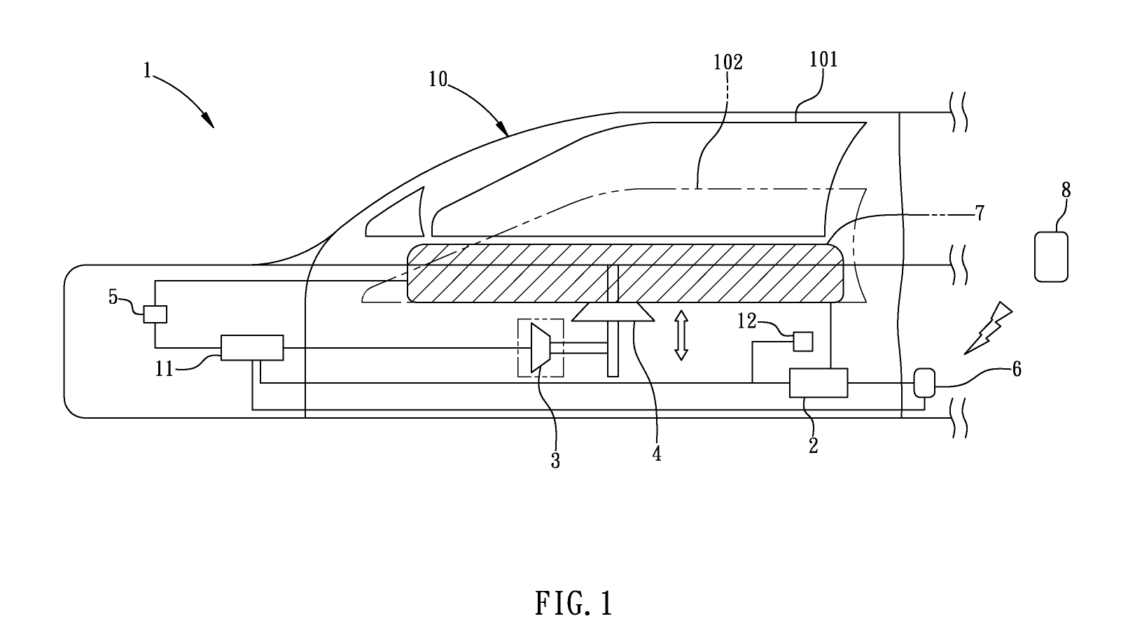

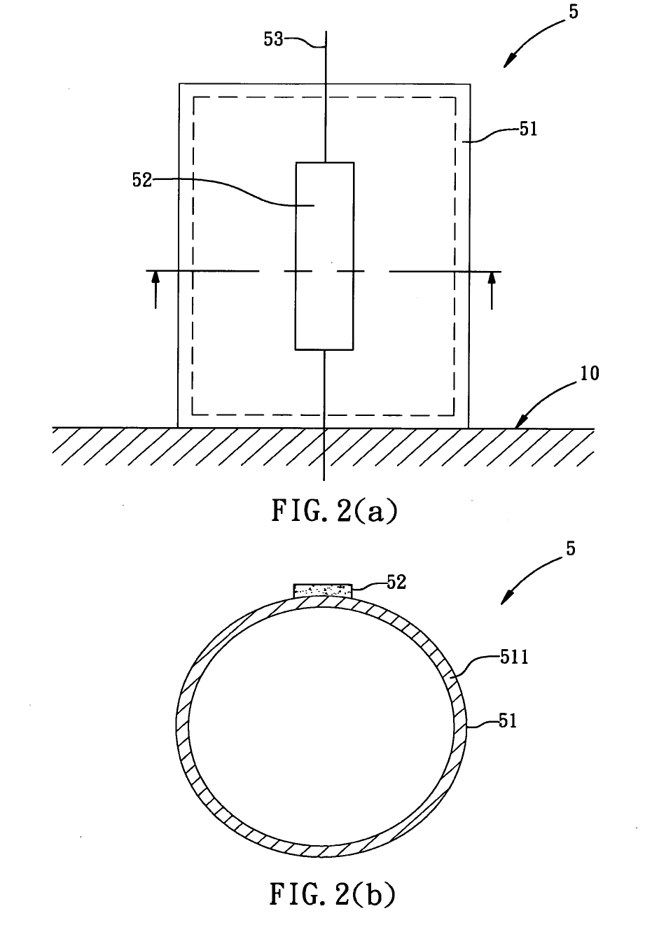

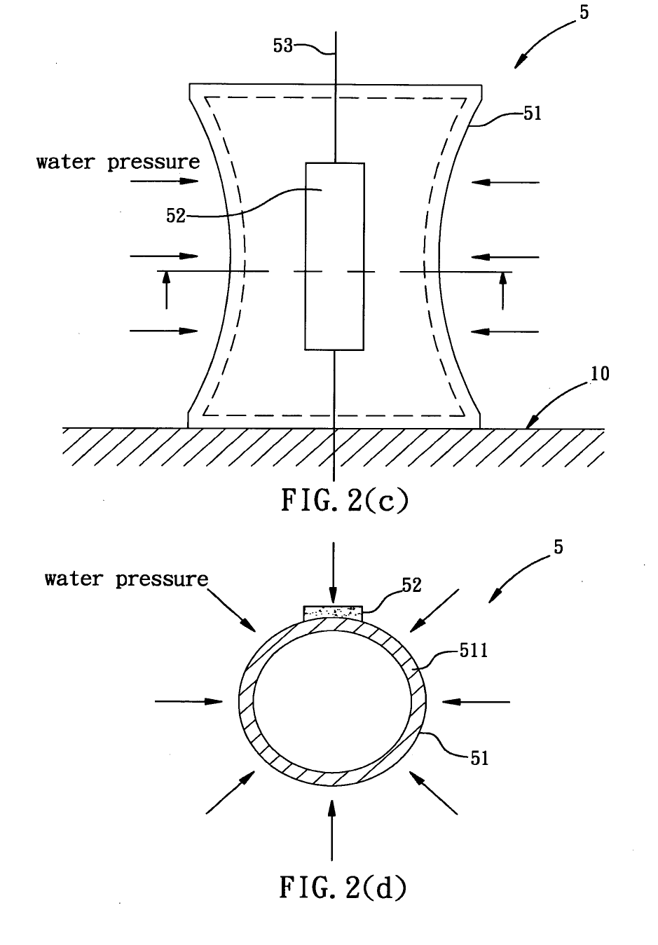

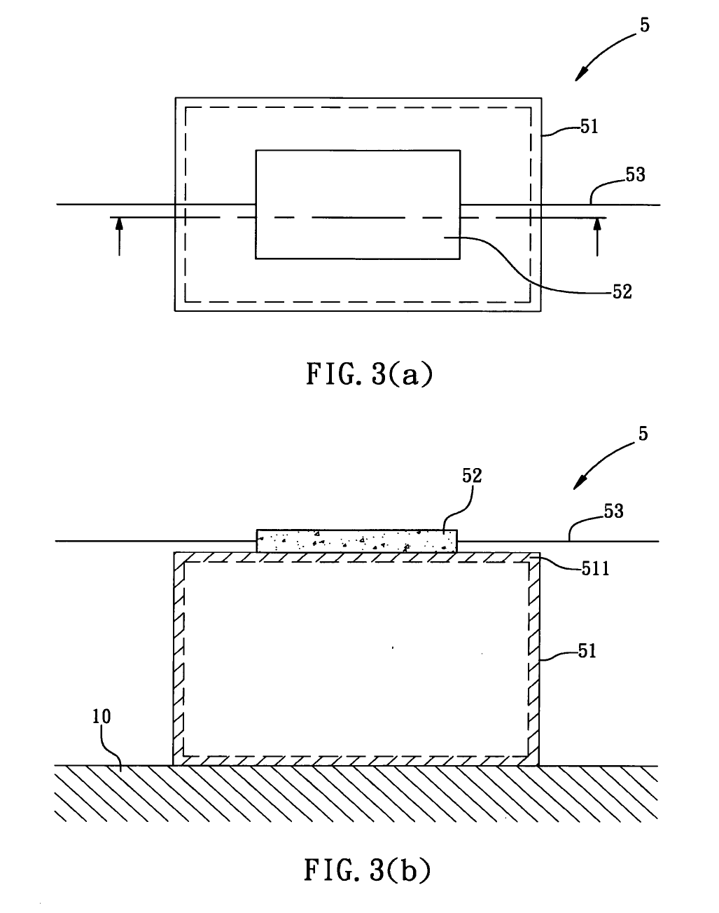

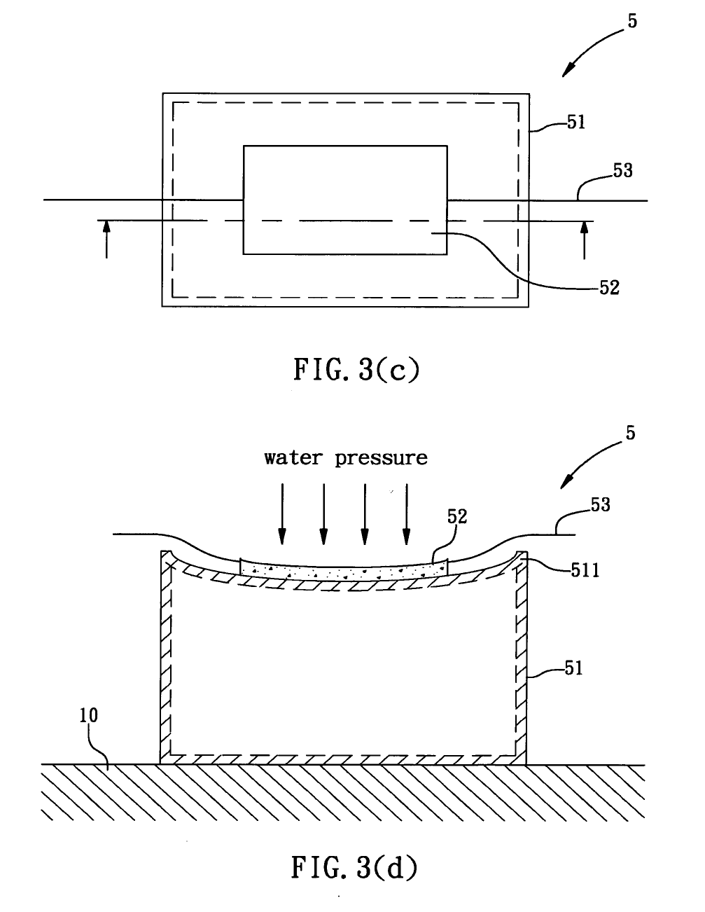

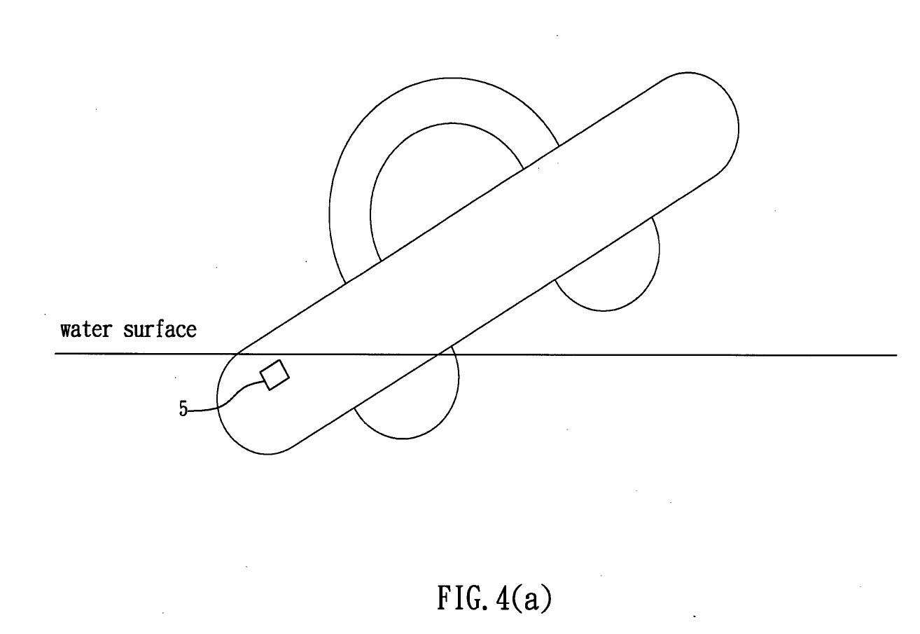

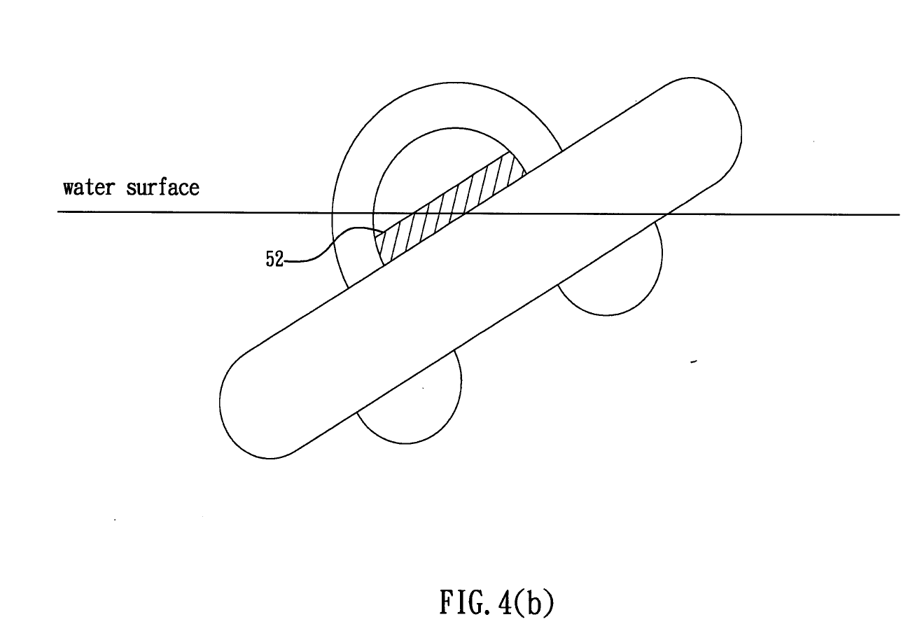

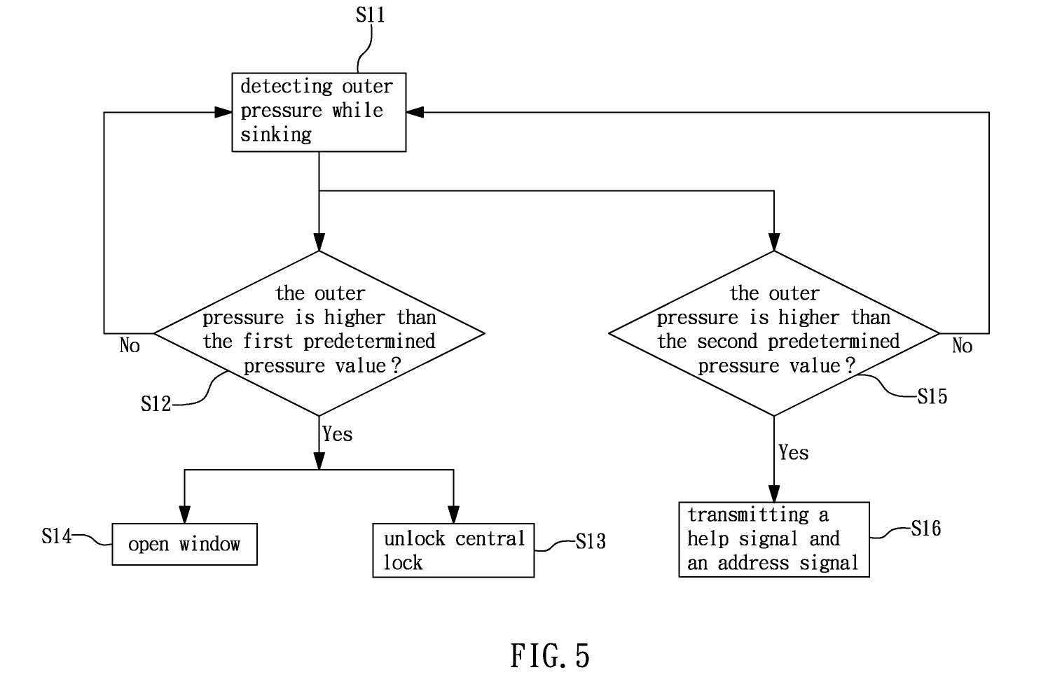

Please refer to FIGS. 1 to 5, wherein FIG. 1 is a schematic drawing of a first embodiment in accordance with the present invention, FIG. 2 is a schematic drawing of a thin film pressure sensor with a closed and hollow carrier having thin-walled and circular ring section in accordance with the present invention, FIG. 3 is a schematic drawing of a thin film pressure sensor with a closed and hollow carrier having thin-walled and hollow box section in accordance with the present invention, FIG. 4 is a schematic drawing of a vehicle sinking into water from the front end of the vehicle resulting from a heavy engine loaded at the front end of the vehicle, and FIG. 5 is an operation process of the first embodiment in accordance with the present invention.

The vehicle is a car for this embodiment, and the apparatus for enhancing a driver to detect and escape from a sinking vehicle 1 is disposed at a body 10 of the car. The body 10 comprises at least one window 101 and at least one window glass 102 and further comprises a battery 11 and a central lock 12.

The apparatus for enhancing a driver to detect and escape from a sinking vehicle 1 of this embodiment comprises a micro-controller unit 2, a motor 3, a lifting unit 4 and a thin film pressure sensor with a closed and hollow carrier 5.

The micro-controller unit 2 is disposed in the body 10 and electrically connected to the battery 11 and the central lock 12. The micro-controller unit 2 is set a first predetermined pressure value P1.

The motor 3 is disposed in the body 10 and electrically connected to the battery 11 and the micro-controller unit 2.

The lifting unit 4 is disposed in the body and cooperated with the window glass 102. The lifting unit 4 is controlled by the motor 3 to go up or go down.

The thin film pressure sensor with a closed and hollow carrier 5 is disposed at a front end of the body. Preferably, the thin film pressure sensor with a closed and hollow carrier 5 is disposed under an engine compartment lid of the car, such as the space near a transmission system or a suspension system arranged in the front end of the car. The thin film pressure sensor with a closed and hollow carrier 5 may be detecting the sinking situation at the initial stage while the vehicle is sinking from the front end of the vehicle resulting from the heavy engine loaded in the front end of the vehicle (shown as FIG. 4). It will strive for more rescue time and have better safe prevention than the disclosure of Taiwanese Patent Application No. 100114760.

Please refer to FIGS. 2 and 3, the thin film pressure sensor 5 comprises a closed and hollow carrier 51 having a membrane 511, a thin film sensing element 52 disposed at a surface of the carrier 51, and two signal transmission lines connected to the thin film sensing element 52 respectively. The carrier 51 may have thin-walled and circular ring section or a thin-walled and hollow box section.

The thin film pressure sensor 5 would not be deformed and then the signal would not be triggered while the vehicle (the car) is normally driven and the inside and outside atmospheric pressures of the membrane 511 are almost the same (about 1 atm pressure unit). However, the outside pressure of the membrane 511 with additional water pressure is more than 1 atm, but the inside pressure of the membrane 511 is keeping 1 atm while the vehicle (the car) is sinking into water. It will result in the deformation of the thin film pressure sensor 5 and the corresponding generation of the output signal where its amplitude is proportion to the sinking depth. Compared to the thin film pressure sensor in accordance with this embodiment, the conventional thin film pressure sensor without a closed and hollow carrier would not be deformed and it is hard to generate the signal(s) to judge whether the vehicle is sinking or not.

According to aforementioned descriptions, the first predetermined pressure value P1 for alarming a dangerous sinking depth is easily set for sinking situation and may not confuse the situations of raining, standing water on the road, and car wash. The thin film sensing element 52 may consist of at least one of following group: a piezo-electric film sensor, a piezo-resistive film sensor, a strain gauge type sensor, a capacitive type sensor, and a resistive type sensor.

Please refer to FIG. 5, the thin film pressure sensor with a closed and hollow carrier 5 is detecting an outer water pressure P while the vehicle (the car) is sinking into water (step S11), and then the micro-controller unit 2 is judging if the outer water pressure P is higher then the first determined pressure value P1 (step S12). If yes, the central lock 12 controlled by the micro-controller unit 2 is unlocked (step S13), and the motor 3 is controlled to make the lifting unit 4 go down and simultaneously the window glass 102 is moved downwardly to open the window 101 (step S14). Furthermore, the window 101 may be a sunroof. If not, back to step S11.

The apparatus for enhancing a driver to detect and escape from a sinking vehicle 1 of this embodiment further comprises an addressing unit 6 and an UPS unit 7. The UPS unit 7 is electrically connected to the battery 11 and may be a solar thin film UPS unit which is attached on a surface of the window glass 102 or embedded in the window glass 102. It is capable of recharging under the sun to be an UPS system or a backup rechargeable battery to prevent power loss from sinking. The invalid battery may result in the power window inactive and further make the safety escaping system lose efficacy. The backup rechargeable battery may replace it immediately to start the power window and then to ensure that the safety escaping system is keeping valid.

The addressing unit 6 may be a GPS which is electrically connected to the battery 11 and the micro-controller unit 2 for transmitting a help signal and an addressing signal to at least one predetermined receiving unit 8. The predetermined receiving unit 8 may be a cell phone, network platform, or a computer, but not limited thereto. The holder of the predetermined receiving unit 8 may be a police unit, a rescue center, a fire agency, or relatives and friends.

The micro-controller unit 2 is further set a second predetermined pressure value P2. The first predetermined pressure value selectively higher or lower than the second predetermined pressure value P2, or equal to the second predetermined pressure value P2. When the vehicle (the car) is sinking and the thin film pressure sensor 5 is detecting an outer water pressure P (step S11), the micro-controller unit 5 is judging if the outer water pressure P higher than the second predetermined pressure value P2 (step S15). If yes, the help signal and the addressing signal are transmitted by the addressing unit 6 immediately to the predetermined receiving unit 8 (step S16). It makes the holders of the predetermined receiving unit 8 can rescue immediately with no delay or uncertainty. If not, back to step S11.

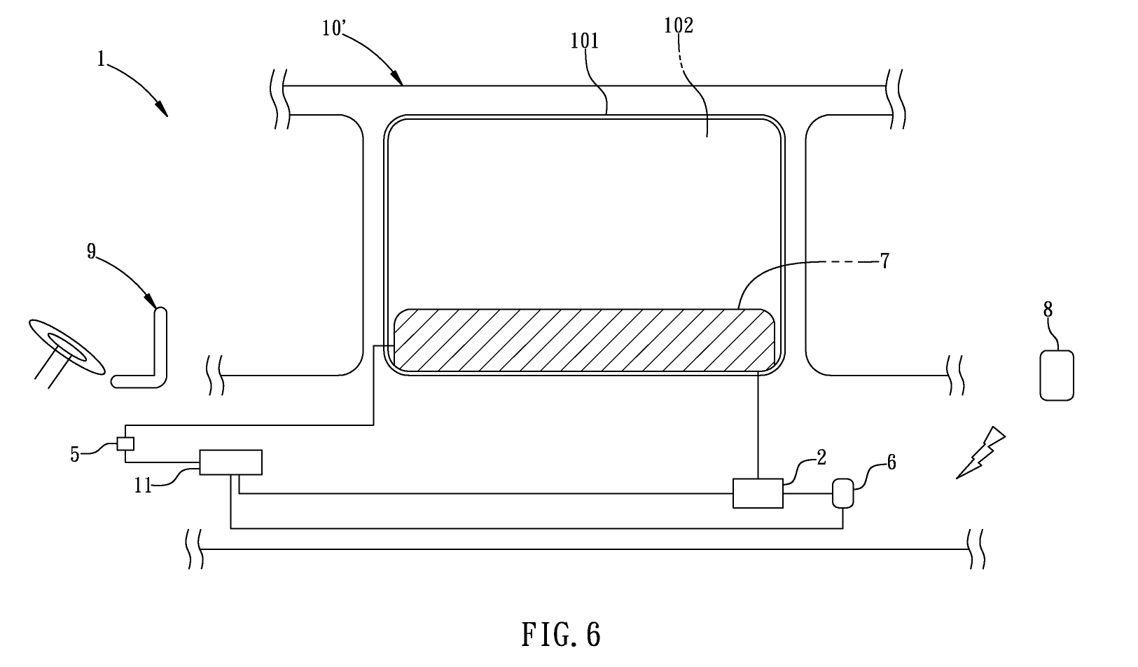

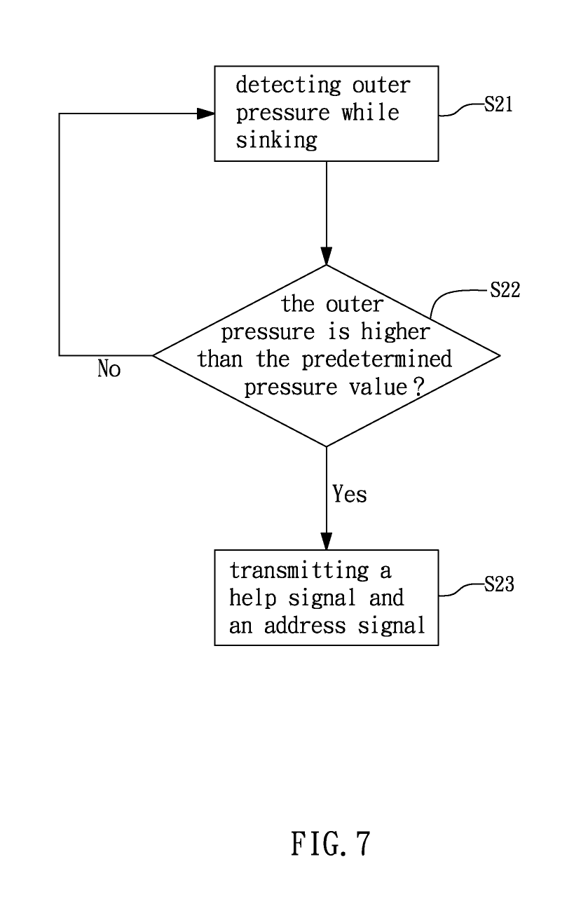

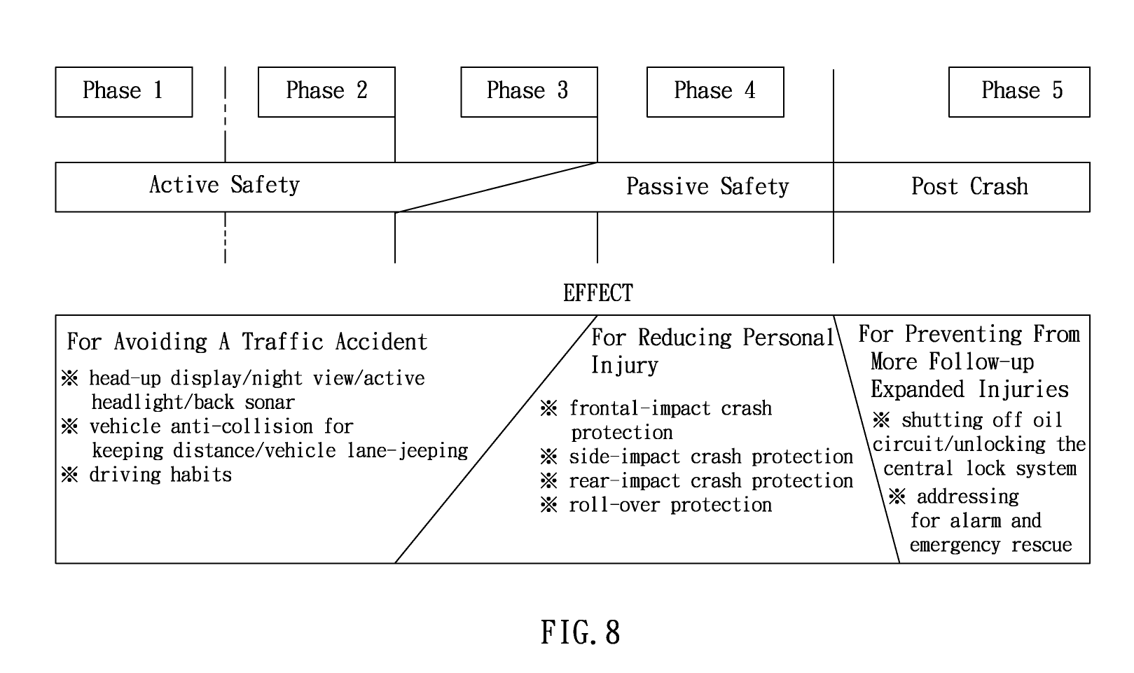

Please refer to FIGS. 6 and 7, which FIG. 6 is a schematic drawing of a second embodiment in accordance with the present invention, and FIG. 7 is an operation process of the second embodiment in accordance with the present invention.

In this embodiment, the vehicle is a bus (not shown), and the apparatus for enhancing a driver to detect and escape from a sinking vehicle 1 is disposed at the body 10′ of the bus. The body 10′ comprises at least one window 101 and at least one window glass 102. The bus further comprises a battery 11.

The apparatus for enhancing a driver to detect and escape from a sinking vehicle 1 of this embodiment comprises a micro-controller unit 2, an addressing unit 6 and a thin film pressure sensor with a closed and hollow carrier 5.

The micro-controller unit 2 is disposed in the body 10′ and electrically connected to the battery 11. The micro-controller unit 2 is set a predetermined pressure value P2.

The addressing unit 6 is electrically connected to the battery 11 and the micro-controller unit 2 for transmitting a help signal and an addressing signal to at least one predetermined receiving unit 8. The predetermined receiving unit 8 may be a cell phone, network platform, or a computer, but not limited thereto. The holder of the predetermined receiving unit 8 may be a police unit, a rescue center, a fire agency, or relatives and friends.

The thin film pressure sensor with a closed and hollow carrier 5 is disposed at a front end of the body 10′. Preferably, the thin film pressure sensor with a closed and hollow carrier 5 is disposed under the driver's seat, such as the space near a transmission system or a suspension system. The thin film pressure sensor with a closed and hollow carrier 5 may be detecting the sinking situation at the initial stage while the vehicle (the bus) is sinking from the front end of the vehicle resulting from the heavy engine loaded in the front end of the vehicle (shown as FID. 4). It will strive for more rescue time and have better safe guarding than the disclosure of Taiwanese Patent Application No. 100114760.

The thin film pressure sensor 5 (shown as FIGS. 2 and 3) comprises a closed and hollow carrier 51 having a membrane 511, a thin film sensing element 52 disposed at a surface of the carrier 51, and two signal transmission lines connected to the thin film sensing element 52 respectively. The carrier 51 may have thin-walled and circular ring section or a thin-walled and hollow box section.

The thin film sensing element 52 may consist of at least one of following group: a piezo-electric film sensor, a piezo-resistive film sensor, a strain gauge type sensor, a capacitive type sensor, and a resistive type sensor. It may be achieved the objective of detecting if the vehicle is sinking into water by the difference between inside and outside pressures of the membrane 511 to generate deformation and the corresponding output signals.

The apparatus 1 further comprises an UPS unit 7. The UPS unit 7 is electrically connected to the battery 11 and may be a solar thin film UPS unit which is attached on a surface of the window glass 102 or embedded in the window glass 102. It is capable of recharging under the sun to be an UPS system or a backup rechargeable battery to prevent power loss from sinking. The invalid battery may result in the power window inactive and further make the safety escaping system lose efficacy. The backup rechargeable battery may replace it immediately to start the power window and then to ensure that the safety escaping system is keeping valid.

Please refer to FIG. 7, when the vehicle (the bus) is sinking into the water and the thin film pressure sensor 5 is detecting an outer water pressure P (step S21), the micro-controller unit 2 is judging if the outer water pressure P is higher than the predetermined pressure value P2 (step S22). If yes, a help signal and an addressing signal is immediately transmitted by the addressing unit 6 to the predetermined receiving unit 8 (step S23). If no, back to the step S21.

Compared to the conventional water level gauges, sensors for water immersion detection, or rain sensors, the apparatus for enhancing a driver to detect and escape from a sinking vehicle 1 of this invention may prevent from confusing the situations of raining, standing water on the road, car wash, and sinking into water. And compared to the patent application no. 100114760, the apparatus for enhancing a driver to detect and escape from a sinking vehicle 1 of this invention may strive for more rescue time (about 20-30 seconds) for passengers.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. An apparatus for enhancing a driver to detect and escape from a sinking vehicle, which is disposed at a body of a vehicle, the body is including at least one window and at least one window glass, the vehicle is further comprising a battery, and the apparatus comprising:
a micro-controller unit, disposed in the body and electrically connected to the battery, the micro-controller unit is set a first predetermined pressure value;
a motor, disposed in the body and electrically connected to the battery and the micro-controller unit;
a lifting unit, disposed in the body and cooperated with the window glass, the lifting unit is controlled by the motor to go up or down; and
a thin film pressure sensor with a closed and hollow carrier, disposed at a front end of the body and electrically connected to the battery and the micro-controller unit;
wherein the motor is controlled by the micro-controller unit to rotate and make the lifting unit go down and simultaneously to drive the window glass downward to open the window while the vehicle is sinking into water and an outer water pressure detected by the thin film pressure sensor is higher than the first predetermined pressure value.

2. The apparatus as claimed in claim 1, further comprising an addressing unit, which is a GPS electrically connected to the battery and the micro-controller unit for transmitting a help signal and an addressing signal to at least one predetermined receiving unit.

3. The apparatus as claimed in claim 1 or 2, further comprising an UPS unit electrically connected to the battery.

4. The apparatus as claimed in claim 3, wherein the UPS unit is a solar thin film UPS unit, which is attached to a surface of the window glass or embedded in the window glass.

5. The apparatus as claimed in claim 2, wherein the micro-controller unit is further set a second predetermined pressure value for transmitting the help signal and the addressing signal to the at least one receiving unit by the addressing unit while the outer water pressure detected by the thin film pressure sensor is higher the second predetermined pressure value.

6. An apparatus for enhancing a driver to detect and escape from a sinking vehicle, which is disposed at a body of a vehicle, the body is including at least one window and at least one window glass, the vehicle is further comprising a battery, and the apparatus comprising:
a micro-controller unit, disposed in the body and electrically connected to the battery, the micro-controller unit is set a predetermined pressure value;
an addressing unit, electrically connected to the battery and the micro-controller unit for transmitting a help signal and an addressing signal to at least one receiving unit; and
a thin film pressure sensor with a closed and hollow carrier, disposed at a front end of the body and electrically connected to the battery and the micro-controller unit;
wherein the help signal and the addressing signal are transmitted to the at least one receiving unit by the addressing unit while an outer water pressure detected by the thin film pressure sensor is higher than the predetermined pressure value.

7. The apparatus as claimed in claim 6, further comprising a UPS unit electrically connected to the battery.

8. The apparatus as claimed in claim 7, wherein the UPS unit is a solar thin film UPS unit, which is attached to a surface of the window glass or embedded in the window glass.

9. The apparatus as claimed in claim 1 or 6, the thin film pressure sensor with a closed and hollow carrier is comprising:
a closed and hollow carrier, having a membrane;
a thin film sensing element, disposed at a surface of the carrier; and
two signal transmission lines, respectively connected to the thin film sensing element.

10. The apparatus as claimed in claim 9, wherein the carrier is with a thin-walled and circular ring section or a thin-walled and hollow box section.

11. The apparatus as claimed in claim 9, wherein the thin film sensing element is consisted of at least one of following group: a piezo-electric film sensor, a piezo-resistive film sensor, a strain gauge type sensor, a capacitive type sensor, and a resistive type sensor.

12. The apparatus as claimed in claim 1 or 6, wherein the window is a sunroof.
